(19) United States
(12) Patent Application Publication
(10) Pub. No.: US 2011/0219773 A1
(43) Pub. Date: Sep. 15, 2011

(54) SYSTEMS AND METHODS FOR PRODUCING HYDROGEN FROM CELLULOSIC AND/OR GRAIN FEEDSTOCKS FOR USE AS A VEHICLE FUEL, USE IN THE PRODUCTION OF ANHYDROUS AMMONIA, AND TO GENERATE ELECTRICITY

(76) Inventor: Steven R. Gerrish, Crawfordsville, IL (US)

(21) Appl. No.: 13/129,097

(22) PCT Filed: Nov. 16, 2009
(86) PCT No.: PCT/US2009/064590

§ 371 Date: May 12, 2011

Related U.S. Application Data
(60) Provisional application No. 61/115,088, filed on Nov. 16, 2008.

(51) Int. Cl. F02C 3/00; F02C 7/22; H01M 8/06; C25B 9/00; C25B 1/04

(52) U.S. Cl. 60/734; 60/805; 429/422; 204/242; 204/278; 205/628; 205/637; 205/552

(57) ABSTRACT

Systems and methods for producing hydrogen from cellulosic and/or grain feedstocks for use as a vehicle fuel, use in the production of anhydrous ammonia, and to generate electricity. In at least one exemplary embodiment of a system for producing ammonia, the system comprises a fuel source containing fuel, a burn chamber coupled to the fuel source for burning the fuel to create energy, an electricity generator coupled to the burn chamber to generate electricity from the energy from the burn chamber, an electrolysis tank coupled to the electricity generator wherein electricity from the electricity generator facilitates the electrolysis of water present within the electrolysis tank to form hydrogen and oxygen, an ammonia reaction chamber coupled to the electrolysis tank, and a compressed air source coupled to the ammonia reaction chamber, wherein the hydrogen and nitrogen from the compressed air source react within the ammonia reaction chamber to generate ammonia.

### PRIORITY

This international patent application is related to, and claims the priority benefit of, U.S. Provisional Patent Application Ser. No. 61/115,088, filed Nov. 16, 2008, the contents of which are hereby incorporated by reference in their entirety into this disclosure.

### BACKGROUND

Anhydrous ammonia, also known as ammonia gas, is widely used throughout the farming industry as a fertilizer for several crops, including corn. It is colorless with a very pungent odor, and comprises one part nitrogen (N) and three parts hydrogen (H), or NH₃. Pure anhydrous ammonia is approximately 82% nitrogen and 18% hydrogen, although trace amounts of oxygen (0.25%-0.5%) are commonly identified with anhydrous ammonia.

The production of ammonia is commonly performed using natural gas as a reaction feedstock. The first step in a commonly-used process is to remove sulfur from the natural gas, as sulfur present within the reaction mixture may effectively deactivate one or more catalysts used in other steps of the process to produce ammonia. The removal of sulfur typically requires catalytic hydrogenation to convert the sulfur compounds into hydrogen sulfide gas:

H₂+RSH→RH+H₂S [1]

The hydrogen sulfide gas is then removed from the reaction mixture using zinc oxide, converting the zinc oxide into zinc sulfide (a solid):

H₂S+ZnO→ZnS+H₂O [2]

The process of catalytic steam reforming of the reaction mixture (now excluding sulfur) is used to generate carbon monoxide (CO) and hydrogen (H₂):

CH₄+H₂O→CO+3H₂ [3]

The next step in the process utilizes catalytic shift conversion to convert carbon monoxide to carbon dioxide, resulting in the production of even more hydrogen:

CO+H₂O→CO₂+H₂ [4]

Carbon dioxide is then removed from the reaction mixture using methods known in the art, including the absorption of carbon dioxide in aqueous ethanolamine solutions or the adsorption of carbon dioxide in pressure swing adsorbers using solid adsorption media known in the art. After the carbon dioxide is removed, a catalytic methanation process is used to remove any residual carbon monoxide and carbon dioxide remaining in the reaction mixture:

CO+3H₂→CH₄+H₂O [5]

and

CO₂+4H₂→CH₄+2H₂O [6]

The final step, namely the catalytic reaction of the resulting hydrogen with nitrogen (from air), will produce anhydrous liquid ammonia. This step is also referred to as the Haber-Bosch process, or the ammonia synthesis loop, and is one of the most commonly used methods to generate ammonia from hydrogen and nitrogen:

3H₂+N₂→2NH₃ [7]

The Haber-Bosch process used to perform step 7 above uses iron oxide as a catalyst at elevated pressures (150-250 atm) and elevated temperatures (300-550° C.), and with several passes of the gases over beds of iron oxide, greater than 98% conversion to anhydrous ammonia can be achieved.

As described above, several steps are required to convert natural gas into anhydrous ammonia, including steps to remove the sulfur from the natural gas itself. Even with these additional steps, the use of natural gas as a feedstock is the most common, which causes the production costs of anhydrous ammonia to vary depending on the then-current cost of natural gas. Fluctuations of the cost of natural gas make it difficult for manufacturers of anhydrous ammonia to estimate production costs over time, and in situations where natural gas prices are high, the cost of manufacturing anhydrous ammonia will be high, making it difficult for consumers, including farmers, to be able to sustain adequate crop production without losing money. In addition, processing natural gas to generate hydrogen as referenced above requires the processing of sulfur, including the production of undesirable hydrogen sulfide gas and zinc sulfide (or other sulfide solid) byproducts which must be properly disposed of.

Therefore, it would be desirable to have more environmentally-friendly systems and methods for the production of hydrogen, which may be useful for the production of nitrogen-based fertilizers, as a vehicle fuel, and for other purposes utilizing hydrogen as a fuel source. Production of hydrogen using, for example, a cellulosic or grain feedstock such as ethanol, instead of natural gas would eliminate steps 1 and 2 above and provide, for example, an environmentally-friendly and economical method for producing anhydrous ammonia. It would further be desirable to have systems useful for the production of electricity utilizing, for example, the hydrogen generated from a cellulosic or grain feedstock. It would also be desirable to have systems useful for the performance of such methods to generate anhydrous ammonia, including, but not limited to, systems and/or subsystems for the production of hydrogen to facilitate the production of anhydrous ammonia.

### BRIEF SUMMARY

In at least one embodiment of a system for producing hydrogen of the present disclosure, the system comprises a fuel source containing fuel, a burn chamber operably coupled to the fuel source, the burn chamber for burning the fuel from the fuel source therewithin to create energy, an electricity generator operably coupled to the burn chamber, the electricity generator operable to generate electricity from the energy from the burn chamber, and an electrolysis tank operably coupled to the electricity generator, wherein the electricity from the electricity generator facilitates the electrolysis of water present within the electrolysis tank to form hydrogen and oxygen.

In at least one embodiment of a system for producing ammonia of the present disclosure, the system comprises a hydrogen source coupled to an ammonia reaction chamber, a compressed air source coupled to the ammonia reaction chamber, and a storage tank coupled to the ammonia reaction chamber for storing ammonia generated within the ammonia reaction chamber.

In at least one embodiment of a system for producing ammonia using a fuel other than natural gas of the present disclosure, the system comprises fuel source containing fuel, a burn chamber operably coupled to the fuel source, the burn chamber for burning the fuel from the fuel source therewithin to create energy, an electricity generator operably coupled to the burn chamber, the electricity generator operable to generate electricity from the energy from the burn chamber, an electrolysis tank operably coupled to the electricity generator, wherein the electricity from the electricity generator facilitates the electrolysis of water present within the electrolysis tank to form hydrogen and oxygen, an ammonia reaction chamber operably coupled to the electrolysis tank, and a compressed air source coupled to the ammonia reaction chamber, wherein hydrogen can react with the nitrogen from the compressed air source to form ammonia within the ammonia reaction chamber.

In at least one embodiment of a method for producing hydrogen of the present disclosure, the method comprises the steps of providing a system for producing hydrogen, comprising a fuel source containing fuel, a burn chamber operably coupled to the fuel source, the burn chamber operable to burn fuel to create energy, an electricity generator operably coupled to the burn chamber, the electricity generator operable to generate electricity from the energy from the burn chamber, and an electrolysis tank operably coupled to the electricity generator, wherein the electricity from the electricity generator facilitates the electrolysis of water present within the electrolysis tank to form hydrogen and oxygen, introducing the fuel from the fuel source to the burn chamber, burning the fuel to create energy, utilizing the energy to generate electricity using the electricity generator, and utilizing the electricity to electrolyze water to form hydrogen and oxygen within the electrolysis tank.

In at least one embodiment of a method for producing ammonia of the present disclosure, the method comprising the steps of providing a system for producing ammonia, comprising a hydrogen source coupled to an ammonia reaction chamber, and a compressed air source coupled to the ammonia reaction chamber, introducing hydrogen from the hydrogen source to the ammonia reaction chamber, introducing nitrogen from the compressed air source to the ammonia reaction chamber, and reacting the hydrogen and nitrogen within the ammonia reaction chamber to generate ammonia. In another embodiment, the system for producing ammonia further comprises a storage tank coupled to the ammonia reaction chamber for storing ammonia generated within the ammonia reaction chamber, and the method further comprises the step of storing the ammonia generated within the ammonia reaction chamber within the storage tank.

In at least one embodiment of a method for producing ammonia of the present disclosure, the method comprises the steps of providing a system for producing ammonia, comprising a fuel source containing fuel, a burn chamber operably coupled to the fuel source, the burn chamber for burning the fuel from the fuel source therewithin to create energy, an electricity generator operably coupled to the burn chamber, the electricity generator operable to generate electricity from the energy from the burn chamber, an electrolysis tank operably coupled to the electricity generator, wherein electricity from the electricity generator facilitates the electrolysis of water present within the electrolysis tank to form hydrogen and oxygen, an ammonia reaction chamber operably coupled to the electrolysis tank, and a compressed air source coupled to the ammonia reaction chamber, introducing the fuel from the fuel source to the burn chamber, burning the fuel to create energy, utilizing energy to generate electricity using the electricity generator, utilizing the electricity to electrolyze water to form hydrogen and oxygen within the electrolysis tank, introducing the hydrogen from the electrolysis tank to the ammonia reaction chamber, introducing nitrogen from the compressed air source to the ammonia reaction chamber, and reacting the hydrogen and the nitrogen within the ammonia reaction chamber to generate ammonia.

In at least one embodiment of a method for producing anhydrous ammonia using ethanol as a fuel source of the present disclosure, the method comprises the steps of burning ethanol to create energy, utilizing the energy to create electricity, utilizing the electricity to electrolyze water to generate hydrogen and oxygen, and reacting the generated hydrogen with nitrogen to form anhydrous ammonia.

In at least one embodiment of a method for producing hydrogen of the present disclosure, the method comprises the steps of introducing fuel to a fuel cell, and utilizing the fuel cell to generate hydrogen. In another embodiment, the method further comprises the step of reacting the generated hydrogen with nitrogen to form ammonia and/or an ammonia-based fertilizer. In an additional embodiment, the method further comprises the step of utilizing the generated hydrogen as a fuel source.

In at least one embodiment of a system for producing hydrogen of the present disclosure, the system comprises a fuel source containing fuel, an electricity generator operably coupled to the fuel source, the electricity generator operable to generate electricity from energy from the fuel, and a fuel cell operably coupled to the electricity generator, wherein electricity from the electricity generator facilitates the cracking of water present within the fuel cell to form hydrogen and oxygen.

In at least one embodiment of a method for producing hydrogen of the present disclosure, the method comprises the steps of providing a system for producing hydrogen, comprising a fuel source containing fuel, an electricity generator operably coupled to the fuel source, the electricity generator operable to generate electricity from energy from the fuel, and a fuel cell operably coupled to the electricity generator, wherein the electricity from the electricity generator facilitates cracking water present within the fuel cell to form hydrogen and oxygen, introducing the fuel from the fuel source to the electricity generator to generate the electricity, and utilizing the electricity to crack water to form the hydrogen and the oxygen within the fuel cell.

In at least one embodiment of a system for producing electricity of the present disclosure, the system comprises a hydrogen source coupled to a fuel cell, an oxygen source coupled to the fuel cell, and a storage tank coupled to the fuel cell for storing electricity generated within the fuel cell.

In at least one embodiment of a method for producing electricity of the present disclosure, the method comprises the steps of providing a system for producing electricity, comprising a hydrogen source coupled to a fuel cell, an oxygen source coupled to the fuel cell, and a storage tank coupled to the fuel cell for storing electricity generated within the fuel cell, introducing the hydrogen from the hydrogen source to the fuel cell, introducing the oxygen from the oxygen source to the fuel cell, and operating the fuel cell to generate electricity.

In at least one embodiment of a business system of the present disclosure, the system comprises a hydrogen production system of the present disclosure, wherein the hydrogen production system is used to generate hydrogen for sale, for use to generate ammonia-based fertilizer, and/or for use to generate electricity.

In at least one embodiment of a method for using a business system of the present disclosure, the method comprises the steps of using money and/or revenue to purchase fuel, using fuel to generate hydrogen using a hydrogen production system, and one or more of the following steps and/or sub-steps: (a) selling hydrogen to generate revenue, and optionally using the generated revenue to purchase fuel; (b) using hydrogen to generate electricity, and optionally: (i) selling the generated electricity to generate revenue, and optionally using the generated revenue to purchase fuel; and/or (ii) using the generated electricity to power the hydrogen production system; (c) using hydrogen to generate ammonia-based fertilizer, and optionally: (i) selling the generated ammonia-based fertilizer to generate revenue, and optionally using the generated revenue to purchase fuel; and/or (ii) using the generated ammonia-based fertilizer to grow crops, and optionally: (A) selling the grown crops to generate revenue, and optionally using the generated revenue to purchase fuel; and/or (B) using the grown crops to generate fuel, and optionally using the generated fuel to generate hydrogen using the hydrogen production system.

In at least one embodiment of a method for producing urea from corn, the method comprises the steps of processing corn to generate ethanol, carbon dioxide, and wastewater, burning the ethanol to create energy, utilizing the energy to create electricity using an electricity generator, utilizing the electricity to electrolyze water to form hydrogen and oxygen within an electrolysis tank, generating anhydrous ammonia using the hydrogen, and reacting the anhydrous ammonia with the carbon dioxide to generate urea. In at least one additional embodiment, the method further comprises comprising the step of combining the urea with the wastewater to generate nitrogen fertilizer. In another embodiment, the method further comprises the step of using the nitrogen fertilizer to grow additional corn.

### BRIEF DESCRIPTION OF THE DRAWINGS

FIG. 1 shows a flow chart of at least one embodiment of a method for producing hydrogen according to the present disclosure;

FIG. 2 shows a diagram of at least a portion of at least one embodiment of a hydrogen production system according to the present disclosure;

FIG. 3 shows a diagram of at least a portion of another exemplary embodiment of a hydrogen production system according to the present disclosure;

FIG. 4 shows a diagram of at least a portion of at least one embodiment of an ammonia production system according to the present disclosure;

FIG. 5A shows a flow chart of at least one embodiment of a method for using a fuel cell to generate hydrogen according to the present disclosure;

FIG. 5B shows an exemplary diagram of at least one embodiment of a cycle for using corn to generate various byproducts according to the present disclosure;

FIG. 6 shows a flow chart of at least one embodiment of a method for producing hydrogen according to the present disclosure;

FIG. 7 shows a diagram of at least a portion of at least one embodiment of an electricity production system according to the present disclosure; and

FIG. 8 shows a diagram of an exemplary embodiment of a business system according to the present disclosure utilizing at least one embodiment of a hydrogen production system according to the present disclosure.

### DETAILED DESCRIPTION

Systems and methods of the disclosure of the present application include efficient and sustainable processes for producing hydrogen, anhydrous ammonia, and electricity, and systems and/or subsystems useful to facilitate the production of the same. For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In at least one embodiment of hydrogen generation of the present disclosure, ethanol is used as a fuel to generate hydrogen, and the generated hydrogen is reacted with nitrogen (compressed air) to ultimately generate anhydrous ammonia. The use of ethanol derived from cellulosic and/or grain sources to produce anhydrous ammonia may be used by farmers, for example, as a fertilizer to grow more corn, demonstrating that the production of anhydrous ammonia may be considered as part of a natural cycle of corn to ethanol to ammonia back to corn. Alternatively, other potential sources of fuel include, but are not limited to, switchgrass, sorghum, and sugar cane, each of which, along with corn, functioning as a renewable and a sustainable source of fuel as described in the natural cycle above. The systems and/or subsystems of the present disclosure operate efficiently as, for example, a cellulosic and/or grain feedstock used as a fuel requires fewer processing steps and results in less waste byproduct (no sulfides) as those feedstocks derive from natural and renewable sources.

Hydrogen produced from one or more of the systems of the present disclosure may be used for several purposes, including, but not limited to, the production of nitrogen-based fertilizers, as a fuel for hydrogen-fuel vehicles, the production of electricity, and for any number of other purposes utilizing hydrogen as a fuel. In at least one embodiment, ethanol is used as a fuel to generate hydrogen, which is then used to prepare anhydrous ammonia.

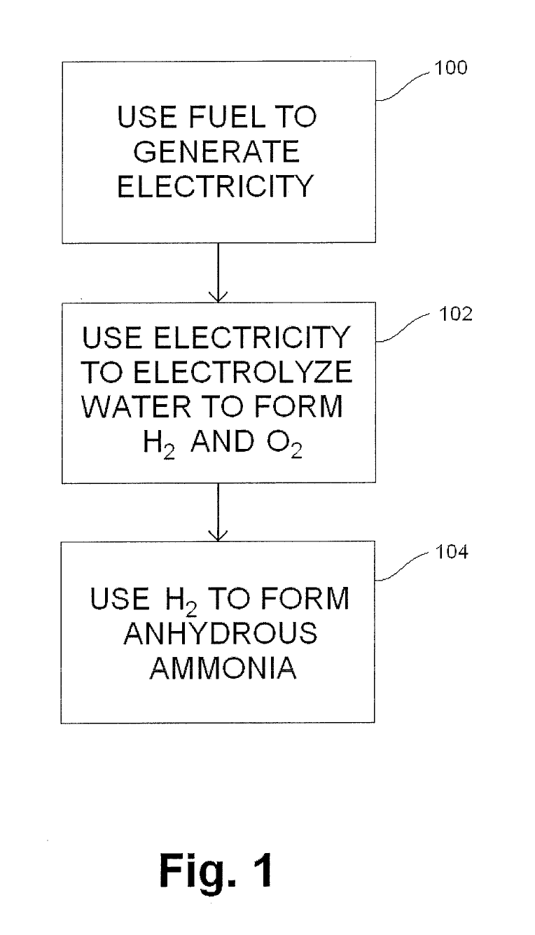

At least one method for producing ammonia of the disclosure of the present application is shown in FIG. 1. As shown in FIG. 1, step 100 involves the use of a fuel to generate electricity. Step 100 may be performed using, for example, a power apparatus as disclosed within U.S. Pat. No. 6,326,703, or another apparatus known in the art useful to generate electricity from fuel. Step 102, as shown in FIG. 1, involves the use of the electricity generated during step 100 to electrolyze water (H₂O) into its component parts, namely hydrogen (H₂) and oxygen (O₂). As disclosed herein, the generation of hydrogen may be based upon the electrolysis of water within an electrolysis tank, the “cracking” of water using a fuel cell (or cell membrane), or from other mechanisms known or developed in the art for splitting water into hydrogen and oxygen. The hydrogen generated by the electrolysis of water in step 102 may then be used, for example, in the production of anhydrous ammonia as shown in step 104.

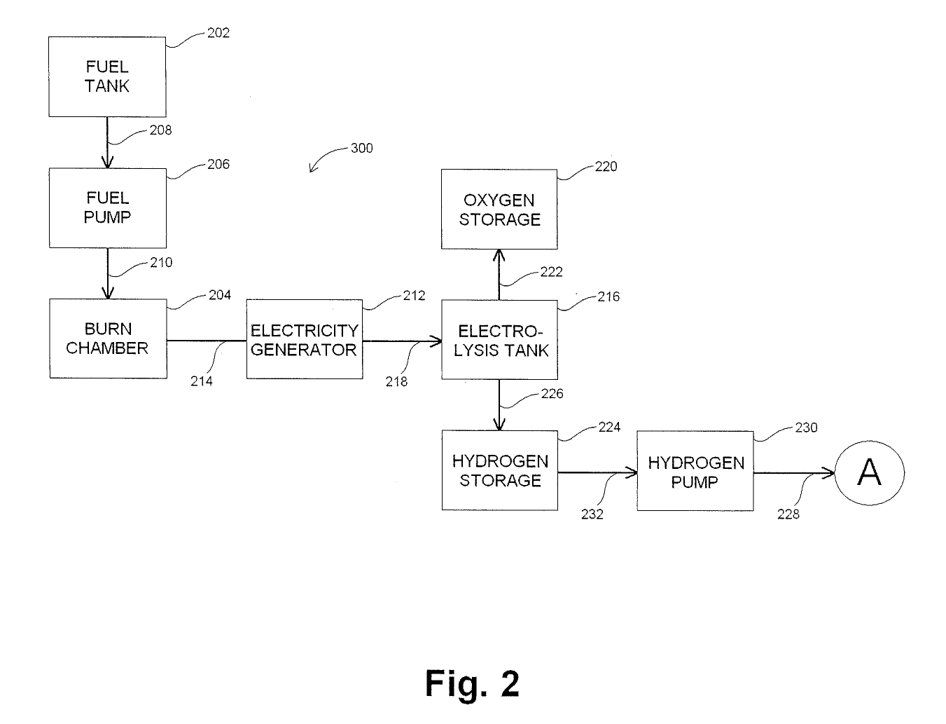

An embodiment of an exemplary hydrogen production system to facilitate the production of anhydrous ammonia, or useful to produce hydrogen for one or more other purposes disclosed herein, is shown in FIG. 2. As shown in FIG. 2, hydrogen production system 300 comprises fuel tank 202 which may include any number of fuels including, but not limited to, ethanol, cellulosic ethanol, methanol, propane, butane, gasoline, oil, and coal. Fuel may be pumped from fuel tank 202 to burn chamber 204 using fuel pump 206. In an embodiment of a hydrogen production system 300 comprising fuel pump 206, fuel would be pumped from fuel tank 202 to burn chamber 204 through conduits 208 and 210. In an exemplary embodiment of a hydrogen production system 300 not comprising a fuel pump 206, fuel would travel through conduits 208, 210 (or a sole conduit, as applicable) from fuel tank 202 to burn chamber 204.

Fuel burned in burn chamber 204 would then facilitate the generation of electricity from electricity generator 212 by, for example, turning a turbine shaft 214, or by the use of another mechanism other than turbine shaft 214 to convert energy (heat or otherwise) created in burn chamber 204 into electricity from electricity generator 212. An electric current (electricity) from electricity generator 212 may then flow to electrolysis tank 216 via conduit 218, whereby the electricity is used to decompose water present within electrolysis tank 216 into hydrogen gas and oxygen gas. Oxygen gas may be stored in oxygen storage tank 220, whereby oxygen from electrolysis tank 216 is transferred to oxygen storage tank 220 through conduit 222. Hydrogen gas may be stored in hydrogen storage tank 224, whereby hydrogen from electrolysis tank 216 is transferred to hydrogen storage tank 224 through conduit 226. Hydrogen stored within hydrogen storage tank 224 may be used for any number of purposes, including, but not limited to, the production of nitrogen-based fertilizers, as a fuel for hydrogen powered vehicles, the production of electricity, and/or for other purposes in which hydrogen may be useful as a fuel.

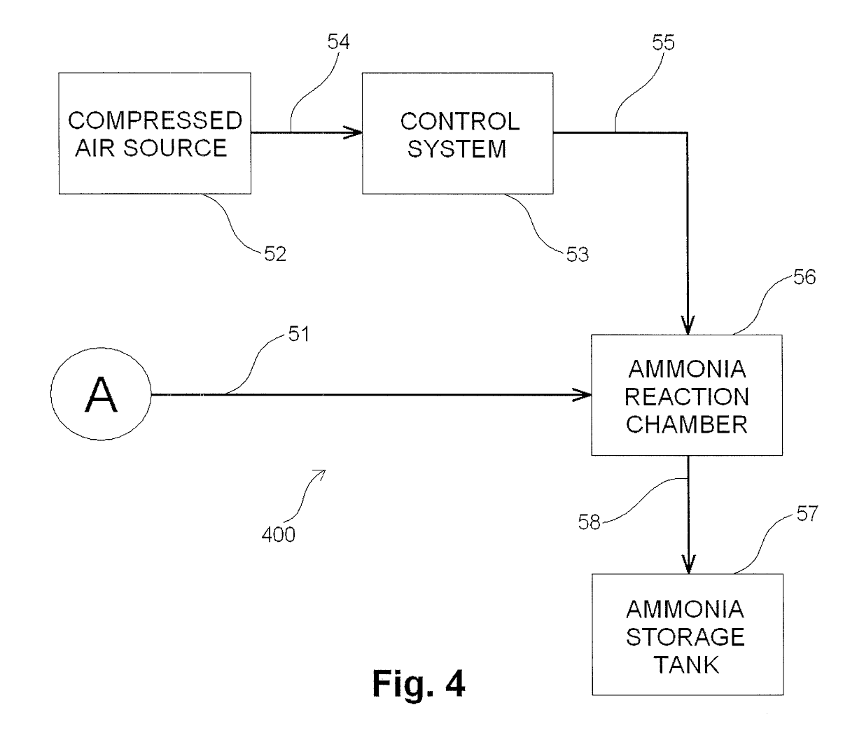

Hydrogen may then be pumped into an ammonia production system 400 from hydrogen pump 230 through conduit 228, whereby hydrogen gas may, for example, enter into ammonia reaction chamber 56 as shown in the exemplary embodiment of an ammonia production system 400 shown in FIG. 4 (noting, for example, that conduit 228 from FIG. 2 and conduit 51 from FIG. 4 may be the same conduit). Hydrogen may, for example, be drawn from hydrogen storage tank 224 by way of conduit 232, or may be drawn directly from electrolysis tank 216 by hydrogen pump 230 through conduits 226 and 232 (which may comprise a single conduit). The encircled “A” shown in FIGS. 2, 3, 4, and 6 are merely present so that the various systems and subsystems shown in FIGS. 2, 3, 4, and 6 may be “connected” to one another by way of multiple drawings.

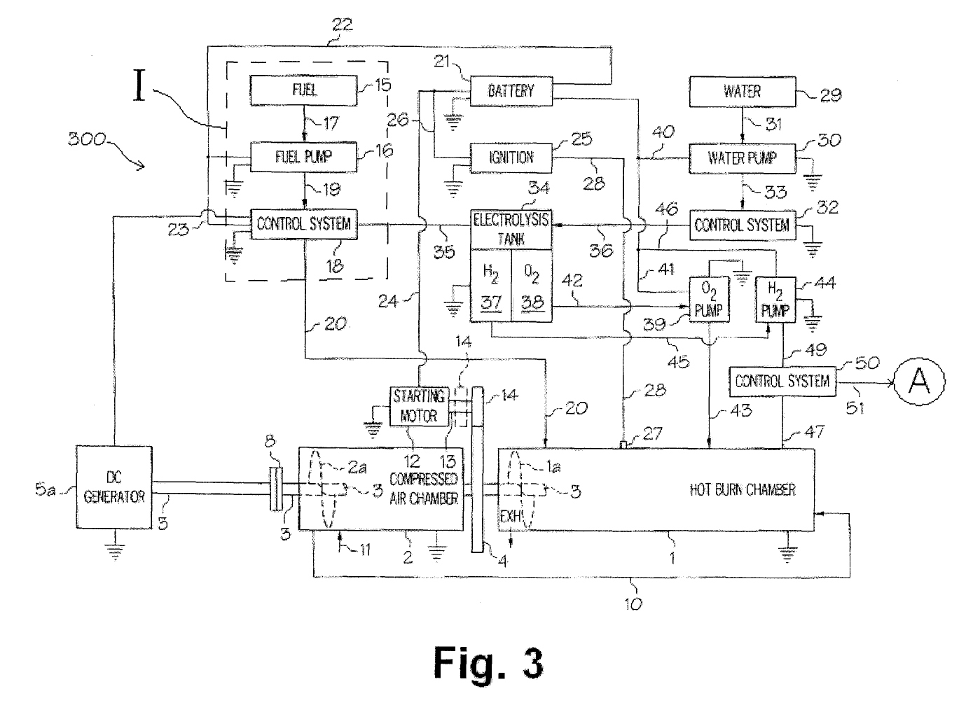

An additional embodiment of an exemplary hydrogen production system 300 to facilitate the production of ammonia in accordance with the disclosure of the present application is shown in FIG. 3. As shown in FIG. 3, hydrogen production system 300 comprises a twin turbine shown as comprising hot burn chamber 1, housing turbine 1a, compressed air chamber 2, housing turbine 2a, wherein housing turbine 1a is connected to compressed air chamber 2 by turbine shaft 3. DC generator 5a is mounted to and is driven by turbine shaft 3. Electric clutch 8 is incorporated in turbine shaft 3 between compressed air chamber 2 and DC generator 5a. Conduit 10 conducts compressed air, after compression in said compressed air chamber 2 by turbine 2a therein, to hot burn chamber 1. Conduit 11 conducts ambient air from the atmosphere into compressed air chamber 2 for compression therein.

In addition, starting motor 12 is connected by shaft 13 to flywheel 14. As shown in solid lines in the drawing, flywheel 14 is engaged with flywheel 4 when the turbine shaft 3 is to be rotated to start turning turbine 1a in hot burn chamber 1. As shown in dotted lines in the same drawing, flywheel 14 can be laterally withdrawn from engagement with flywheel 4, or is otherwise disengaged from flywheel 4 when hot burn chamber 1 has been started and is operating.

An exemplary hydrogen production system 300 as shown in FIG. 3 may further comprise a tank 15 containing fuel, which may include any number of fuels including, but not limited to, ethanol, cellulosic ethanol, methanol, propane, butane, gasoline, oil, and coal. Fuel pump and injection system 16 receives fuel from tank 15 through conduit 17. Engine control system 18 receives fuel from fuel pump and injection system 16 through conduit 19. Fuel subsystem I (comprising tank 15, fuel pump and injection system 16, and engine control system 18), in an exemplary embodiment, is designed for liquid fuel. If solid fuel (coal, for example) is desired, fuel subsystem I could be modified/adapted accordingly. Flexibility with fuel subsystem I permits an exemplary hydrogen production system 300 to be situated adjacent to its fuel source. For example, hydrogen production system 300 could be located underground, adjacent to a source of coal.

Conduit 20 conducts fuel from engine control system 18 to hot burn chamber 1. Battery 21 provides electrical power through line 22 to fuel pump and injection system 16, and through line 23 to engine control system 18. Battery 21 also provides electrical power through line 24 to starting motor 12. Ignition system 25 is powered by battery 21 through line 26. Igniter plug 27, mounted in/on hot burn chamber 1, is powered by ignition system 25 through line 28. Tank 29 holds water which is conducted to water pump 30 through conduit 31. Conduit 33 conducts water from water pump 30 to engine control system 32. Electrolysis tank 34 receives water from engine control system 32 through conduit 36. Electrolysis tank 34 receives D.C. current from engine control system 18 through line 35 and electrolyzes water to produce hydrogen gas which is held in hydrogen accumulator chamber 37, and oxygen gas which is held in oxygen accumulator chamber 38. Battery 21 provides electrical power through line 40 to water pump 30, through line 41 to oxygen pump 39, and through line 46 to hydrogen pump 44. Oxygen pump 39 receives oxygen from oxygen accumulator chamber 38 through conduit 42, and pumps oxygen to hot burn chamber 1 through conduit 43.

An exemplary hydrogen production system 300 as shown in FIG. 3 may further comprise a hydrogen pump 44 to receive hydrogen from hydrogen accumulator chamber 37 through conduit 45, whereby hydrogen pump 44 pumps hydrogen to control system 50 through conduit 49. Control system 50, in an exemplary embodiment, would allocate distribution of hydrogen between hot burn chamber 1 (via conduit 47), where the hydrogen is burned to produce electricity to power an exemplary hydrogen production system 300, and to an exemplary ammonia production system 400 (referenced in further detail herein), whereby some or all the hydrogen from control system 50 would be consumed to produce ammonia. Control system 50, in accordance with the foregoing, would be configured to optimize the allocation of hydrogen between hot burn chamber 1 of hydrogen production system 300 and ammonia production system 400. In an exemplary power apparatus known in the art, namely the apparatus disclosed within U.S. Pat. No. 6,326,703, hydrogen pump 44 pumps hydrogen to hot burn chamber 1 through conduit 47 and does not pump any hydrogen to any other apparatus and/or portion of an apparatus of the power apparatus disclosed within the aforementioned patent.

Various ground connections, shown but not identified by numerals, are provided and are so well known in the electrical arts as not to require further description.

Operation of the exemplary hydrogen production system 300 shown in FIG. 3 is described as follows. In at least one exemplary embodiment, fuel from tank 15 is conducted to fuel pump and injection system 16, thence to engine control system 18, and finally to hot burn chamber 1, which is fed compressed air through conduit 10. Battery 21 operates starting motor 12 and, with flywheel 14 engaged, as shown in solid lines, with flywheel 4, turns over turbine shaft 3 which operates hot burn chamber 1 and compressed air chamber 2 by turning over turbines 1a and 2a therein. Battery 21 supplies power to ignition system 25 which feeds power to igniter plug 27 in/on hot burn chamber 1. In this manner, the fuel is ignited, initially burning with compressed air in said hot burn chamber 1, and starts hot burn chamber 1 operating by rotating turbine 1a therein.

Water from tank 29 is then fed by water pump 30 to engine control system 32 and thence to electrolysis tank 34. DC generator 5a, mounted to turbine shaft 3, is caused to rotate and thus feeds an electrical current through engine control system 18 to electrolysis tank 34 which, under the influence of the DC current, decomposes water into hydrogen gas and oxygen gas. These gases are introduced by way of oxygen pump 39 into hot burn chamber 1, and by way of hydrogen pump 44 to control system 50, whereby control system 50 allocates a portion of hydrogen to ammonia production system 400 and a portion of hydrogen to hot burn chamber 1 of hydrogen production system 300. The fuel flame causes the hydrogen gas to burn in the oxygen gas, such highly efficient combustion of the hydrogen gas in the oxygen gas generating gaseous products of combustion which operate turbine 1a in hot burn chamber 1. It will be apparent that the rate of introduction of fuel and hydrogen and oxygen gases into hot burn chamber 1 can be regulated and controlled by engine control systems 18 and 32, to result in the desired level of power produced by hot burn chamber 1 and thus to control the level of electrical output of D.C. generator 5a. It will also be apparent that, with the combusting of hydrogen gas in oxygen gas in hot burn chamber 1, the rate of feed of fuel can be reduced over that initially required to start the operation.

FIG. 4 shows an exemplary embodiment of ammonia production system 400 in connection with the exemplary embodiment of a hydrogen production system 300 shown in FIG. 3. As shown in FIG. 4, ammonia production system 400 comprises conduit 51 to allow hydrogen from a hydrogen production system 300 (referred to generally as a “hydrogen source”) to enter ammonia reaction chamber 56 to facilitate the production of ammonia, including, but not limited to, the production of anhydrous ammonia. Ammonia production system 400 further comprises compressed air source 52, said compressed air source 52 containing air, which typically comprises approximately 78% nitrogen (N₂), 21% oxygen (O₂), and 1% other gases. Air from compressed air source 52 would flow to control system 53 via conduit 54, wherein control system 53 would be configured to optimize the introduction of air (including nitrogen) into ammonia reaction chamber 56 through conduit 55. Ammonia reaction chamber 56 may be configured to optimize the production of ammonia by, for example, allowing for increased pressure, temperature, and the introduction of one or more catalysts as referenced herein. Ammonia created within ammonia reaction chamber 56 may optionally be stored in ammonia storage tank 57, and may flow from ammonia reaction chamber 56 to ammonia storage tank 57 through conduit 58.

The embodiment of the ammonia production system 400 shown in FIG. 4 is an exemplary embodiment of a ammonia production system 400 of the present disclosure, and is not intended to be the single possible embodiment of an ammonia production system 400. For example, an exemplary ammonia production system 400 may comprise additional control systems to regulate the flow of hydrogen and/or nitrogen from their respective sources to the ammonia reaction chamber 56.

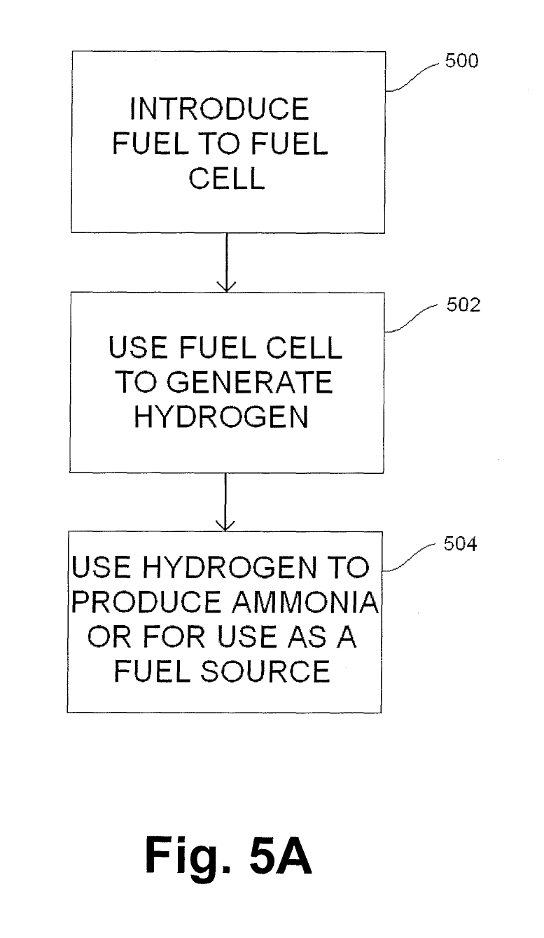

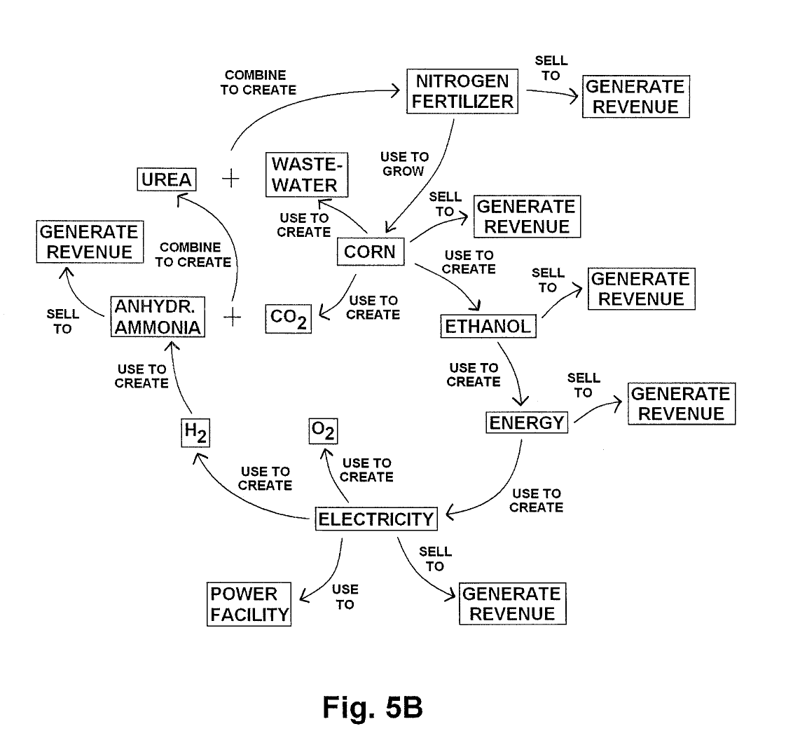

At least one method for producing hydrogen of the disclosure of the present application is shown in FIG. 5a. As shown in FIG. 5a, step 500 involves the introduction of a fuel to a fuel cell. An exemplary fuel may be as described herein, and may comprise fuel from cellulosic and/or grain sources. A fuel cell, as referenced within the present application, would operate in at least one embodiment to “crack” water into hydrogen and oxygen, recognizing that any number of fuel cells either known in the art or created in the art operable to generate hydrogen from a fuel could be useful in performing one or more methods of the present application. Step 502 involves the use of a fuel cell, as referenced herein, to generate hydrogen, which may include, but is not limited to, the use of ethanol as a fuel to generate hydrogen by cracking water into its component hydrogen and oxygen. Step 504 involves the use of the hydrogen generated in step 502 for any number of purposes, including, but not limited to, the production of ammonia (as described, for example in FIG. 4), the production of any number of other nitrogen-based fertilizers, as a fuel source for vehicles, and/or any other uses for hydrogen as a fuel and/or a reactant known in the art or created in the art. Exemplary nitrogen-based fertilizers include, but are not limited to, anhydrous ammonia, urea, ammonium nitrate, URAN 32 (or UAN 32), ureaformaldehyde, ammonium sulfate, diammonium phosphate, monoammonium phosphate, calcium nitrate, potassium nitrate, ammonium thiosulfate, urea ammonium nitrate, and calcium ammonium nitrate.

Urea, an exemplary nitrogen-based fertilizer, may also be prepared in accordance with the present disclosure by using carbon dioxide (CO₂) generated during ethanol production. As referenced generally herein, ethanol is at least one fuel source which may be derived from corn. During the process of producing ethanol from corn, CO₂ and wastewater are generated as a reaction byproduct. Therefore, and in at least one embodiment of an exemplary hydrogen production system of the present disclosure, the system comprises the conversion of corn to produce, at least, ethanol, CO₂, and wastewater, whereby the ethanol may be used as an exemplary fuel source as generally referenced herein, and the CO₂ may be used to produce urea, and the wastewater may be used to produce any number of liquid nitrogen fertilizers.

The production of urea (NH₂CONH₂), in at least one embodiment, may comprise combining the CO2 byproduct from ethanol production with ammonia to create urea using the following two-step process having an ammonium carbamate (NH₂COONH₄) intermediate:

2NH₃+C0₂⇄NH₂COONH₄ [8]

NH₂COONH₄⇄H₂O+NH₂CONH₂ [9]

Furthermore, and as referenced above, the production of ethanol from corn also generates a wastewater byproduct, comprising nitrogen (N), phosphorous (P), and potassium (K). The wastewater, in at least one embodiment, may then be reacted with urea to generate any number of liquid fertilizers, including, but not limited to, a 28-0-0 liquid fertilizer. Such fertilizers may then be reused by farmers to grow more crops, including corn, instead of having the wastewater enter waterways and rivers. An exemplary comprehensive diagram showing the cycle of using corn to produce the aforementioned products is shown in FIG. 5B, and is included as one exemplary cycle connecting the various products and processes disclosed within the present application.

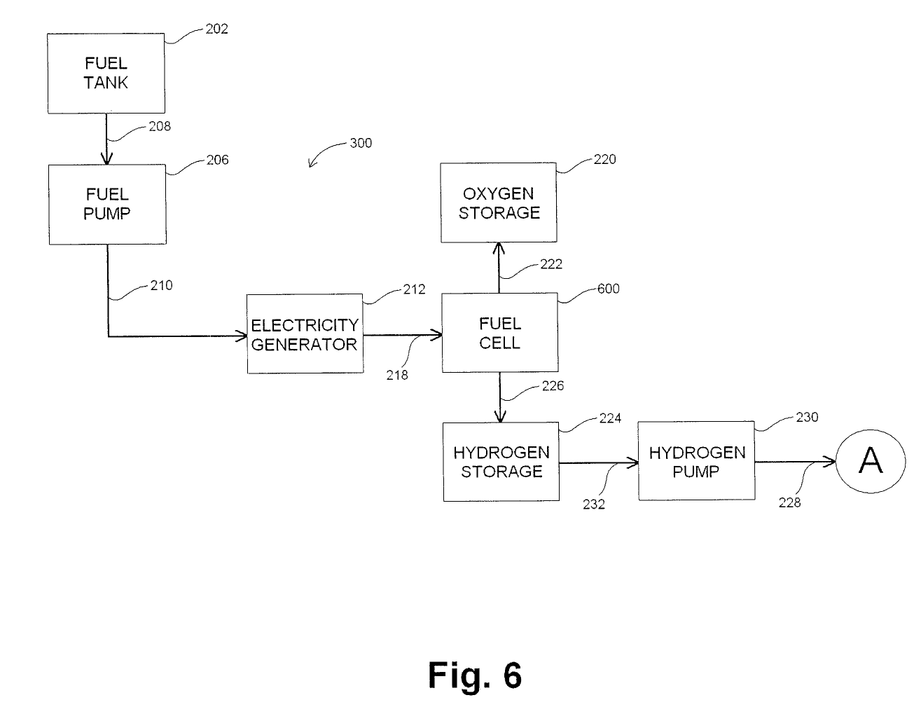

An additional embodiment of an exemplary hydrogen production system in accordance with the disclosure of the present application is shown in FIG. 6. As shown in FIG. 6, hydrogen production system 300 comprises fuel tank 202 which may include any number of fuels including, but not limited to, ethanol, cellulosic ethanol, methanol, propane, butane, gasoline, oil, and coal. Fuel may be pumped from fuel tank 202 to electricity generator 212 using fuel pump 206. In an embodiment of a hydrogen production system 300 comprising fuel pump 206, fuel would be pumped from fuel tank 202 to electricity generator 212 through conduits 208 and 210. In an exemplary embodiment of a hydrogen production system 300 not comprising a fuel pump 206, fuel would travel through conduits 208, 210 (or a sole conduit, as applicable) from fuel tank 202 to electricity generator 212.

Electricity generator 212, in an exemplary embodiment, would use fuel from fuel tank 202 to generate electricity using any number of mechanisms known in the art to generate electricity from fuel. An electric current (electricity) from electricity generator 212 may then flow to fuel cell 600 via conduit 218, whereby the electricity is used by fuel cell 600 to “crack” water present within fuel cell 600 into hydrogen gas and oxygen gas. As referenced herein, a “fuel cell” may comprise any number of fuel cells and/or fuel membranes known or developed in the art operable to “crack” water into hydrogen and oxygen. Oxygen gas may be stored in oxygen storage tank 220, whereby oxygen from fuel cell 600 is transferred to oxygen storage tank 220 through conduit 222. Hydrogen gas may be stored in hydrogen storage tank 224, whereby hydrogen from fuel cell 600 is transferred to hydrogen storage tank 224 through conduit 226.

Hydrogen may then be pumped into, for example, an ammonia production system 400 from hydrogen pump 230 through conduit 228, whereby hydrogen gas may, for example, enter into ammonia reaction chamber 56 as shown in the exemplary embodiment of an ammonia production system 400 shown in FIG. 4 (noting, for example, that conduit 228 from FIG. 1 and conduit 51 from FIG. 4 may be the same conduit). Hydrogen may, for example, be drawn from hydrogen storage tank 224 by way of conduit 232, or may be drawn directly from electrolysis tank 216 by hydrogen pump 230 through conduits 226 and 232 (which may comprise a single conduit).

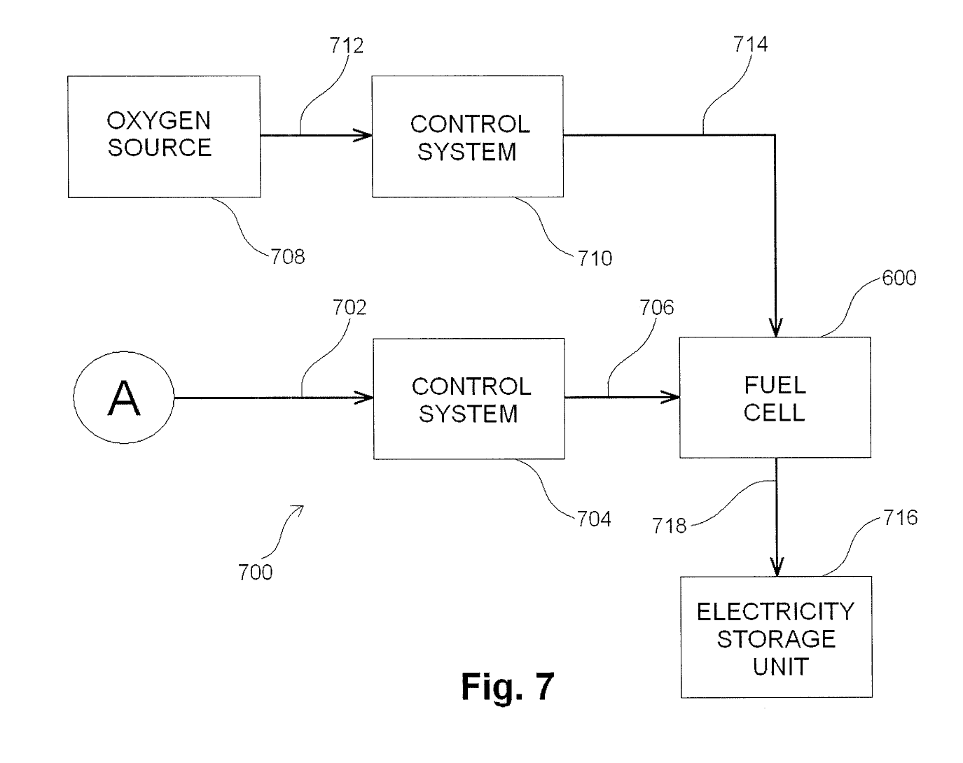

FIG. 7 shows an exemplary embodiment of an electricity generation system 700 of the disclosure of the present application using, for example, hydrogen produced by a hydrogen production system 700 of the present disclosure. As shown in FIG. 7 electricity generation system 700 comprises conduit 702 to allow hydrogen from a hydrogen production system 300 (referred to generally as a “hydrogen source”) to ultimately enter fuel cell 600 to facilitate the production of electricity. Electricity generation system 700 may further comprise control system 704 operably coupled between the hydrogen source and fuel cell 600, wherein control system 704 would be configured to optimize the introduction of hydrogen into fuel cell 600 through conduit 706.

An exemplary hydrogen production system 700 of the present disclosure further comprises an oxygen source 708 which may comprise, but is not limited to, a source of compressed oxygen, compressed air, or a mechanism for introducing oxygen, air, or another gaseous mixture containing oxygen, into fuel cell 600. Oxygen from oxygen source 708 may flow to control system 710 via conduit 712, wherein control system 710 would be configured to optimize the introduction of oxygen into fuel cell 600 through conduit 714. Electricity generated by fuel cell 600 may be stored in an electricity storage unit 716 by way of conduit 718 from fuel cell 600. Electricity may be used from fuel cell 600 and/or electricity storage unit 716, either directly therefrom or from one or more other mechanisms coupled thereto, for any number of purposes known or created in the art including, but not limited to, those purposes that may utilize electricity, including the power operation of homes and buildings, operating various motors and/or engines, including vehicular engines, and to operate power generation systems.

In addition to the foregoing, hydrogen generated by one or more hydrogen generation systems 300 of the disclosure of the present application may be stored in one or more storage tanks and/or sold in a business setting for any number of purposes. For example, hydrogen may be generated using an exemplary hydrogen production system 300 of the present disclosure, and may be sold to a third party for a fee, wherein the fee may be used, for example, to facilitate the purchase of additional fuel to generate more hydrogen. Hydrogen may, for example, be used by a purchaser of hydrogen as a fuel to, for example, generate heat.

Regarding exemplary hydrogen production systems 300, ammonia production systems 400, and/or electricity production systems 700 of the present disclosure, those systems may further comprise one or more control mechanisms operably coupled between the various components of the systems to control the flow of fuel, energy, electricity, hydrogen, oxygen, and/or ammonia, as applicable, between one component to another component. In addition, exemplary hydrogen production systems 300, ammonia production systems 400, and/or electricity production systems 700 of the present disclosure may further comprise one or more conduits operably coupled between the various components of the systems to allow for the flow of fuel, energy, electricity, hydrogen, oxygen, and/or ammonia, as applicable, between one component to another component.

Furthermore, the exemplary hydrogen production systems 300, ammonia production systems 400, and/or electricity production systems 700 of the present disclosure may be operably coupled to one another in any number of configurations. For example, an exemplary hydrogen production system 300 of the present disclosure utilizing a fuel cell/membrane which uses electricity to generate hydrogen may be used in connection with an exemplary electricity production system 700 of the present disclosure using a different type of fuel cell/membrane which uses hydrogen and oxygen to generate electricity.

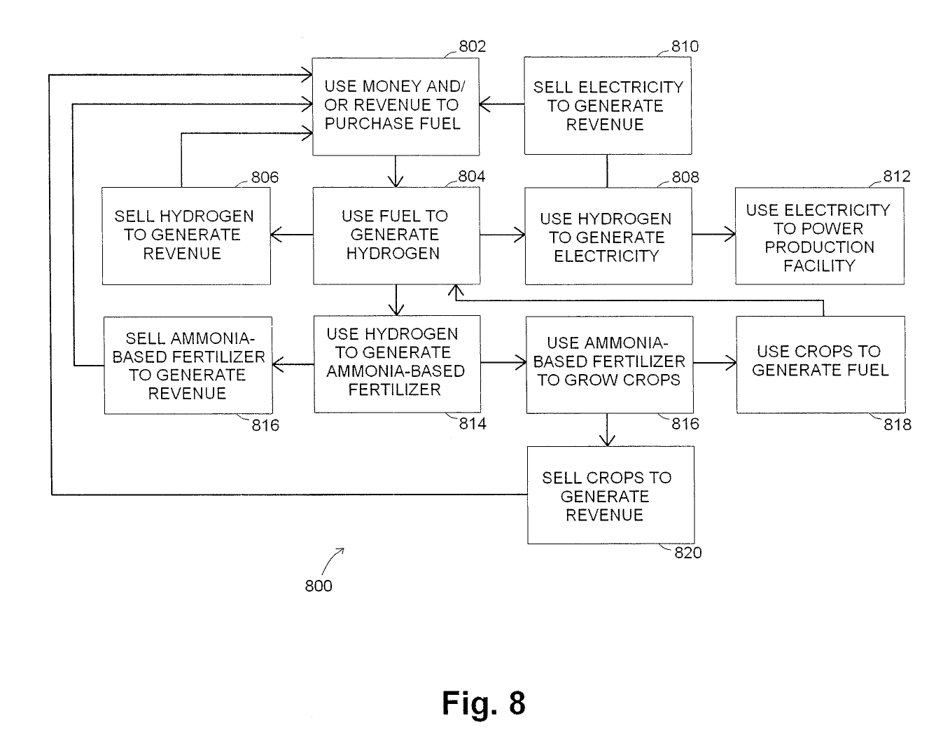

The various systems of the disclosure of the present application may, for example, be used in a business setting as disclosed in the exemplary business system shown in FIG. 8. As shown in the exemplary embodiment shown in FIG. 8, business system 800 comprises step 802, whereby money (and/or revenue generated by business system 800) is used to purchase fuel for use, for example, with an exemplary hydrogen production system 300 of the present disclosure. In step 804, the fuel purchased in step 802 may be used to generate hydrogen using, for example, an exemplary hydrogen production system 300 of the present disclosure. The hydrogen produced in step 804 may be sold, as shown in step 806, to generate revenue. The revenue generated in step 806 may be used, for example, to purchase fuel as shown in step 802.

Hydrogen generated in step 804 may also be used to generate electricity as shown in step 808. The electricity generated in step 808 may, for example, be sold to generate revenue as shown in step 810, and the revenue generated in step 810 may be used, for example, to purchase fuel as shown in step 802. In addition, the electricity generated in step 808 may, for example, be used to power one or more production systems of the present disclosure as shown in step 812.

In addition to the foregoing, hydrogen generated in step 804 may also be used to generate ammonia-based fertilizer as shown in step 814. The ammonia-based fertilizer generated in step 814 may, for example, be sold to generate revenue as shown in step 816, and the revenue generated in step 816 may be used, for example, to purchase fuel as shown in step 802. The ammonia-based fertilizer generated in step 814 may also, for example, be used to grow crops as shown in step 816. The crops may then be used, as shown by step 818, to generate fuel, which may then be used to generate hydrogen according to step 804. The crops generated in step 816 may, for example, be sold to generate revenue as shown in step 820, and the revenue generated in step 820 may be used, for example, to purchase fuel as shown in step 802. The exemplary business system 800 shown in FIG. 8 is only one exemplary business system 800 contemplated by the present disclosure, recognizing that, for example, one or more steps shown in FIG. 8 may be omitted and/or used differently than as disclosed. For example, fuel generated in step 818 may also be sold to generate revenue, or the fuel may be used for purposes other than to generate additional hydrogen.

While various embodiments of systems, subsystems, and methods for producing hydrogen, nitrogen-based fertilizers, electricity, and revenue using cellulosic and/or grain feedstocks been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for producing hydrogen, the system comprising:
a fuel source containing fuel;
a burn chamber operably coupled to the fuel source, the burn chamber for burning the fuel from the fuel source therewithin to create energy;
an electricity generator operably coupled to the burn chamber, the electricity generator operable to generate electricity from the energy from the burn chamber; and
an electrolysis tank operably coupled to the electricity generator, wherein the electricity from the electricity generator facilitates electrolysis of water present within the electrolysis tank to form hydrogen and oxygen.

2. The system of claim 1, wherein the fuel comprises a fuel selected from the group consisting of ethanol, cellulosic ethanol, methanol, propane, butane, gasoline, oil, and coal.

3. The system of claim 1, wherein the electricity generator is operably coupled to the burn chamber by way of a turbine shaft, and wherein the energy created within the burn chamber is operable to turn the turbine shaft to facilitate the generation of the electricity from the electricity generator.

4. The system of claim 1, further comprising a fuel pump operably coupled between the fuel tank and the burn chamber, the fuel pump operable to pump the fuel from the fuel tank to the burn chamber.

5. The system of claim 1, further comprising an oxygen storage tank operably coupled to the electrolysis tank, the oxygen storage tank capable of storing the oxygen created within the electrolysis tank.

6. The system of claim 1, further comprising an hydrogen storage tank operably coupled to the electrolysis tank, the hydrogen storage tank capable of storing the hydrogen created within the electrolysis tank.

7. The system of claim 6, further comprising a hydrogen pump operably coupled to the hydrogen storage tank, the hydrogen pump operable to pump the hydrogen from the hydrogen storage tank.

8. The system of claim 1, further comprising a hydrogen pump operably coupled to the electrolysis tank, the hydrogen pump operable to pump the hydrogen from the electrolysis tank.

9. The system of claim 6, further comprising:
an ammonia reaction chamber configured to receive hydrogen from one or more of the electrolysis tank and the hydrogen storage tank coupled to the ammonia reaction chamber;
a compressed air source coupled to the ammonia reaction chamber; and
a storage tank coupled to the ammonia reaction chamber for storing ammonia generated within the ammonia reaction chamber.

10. The system of claim 9, further comprising a control system operably coupled to one or more of the electrolysis tank, the hydrogen storage tank, and the ammonia reaction chamber, the control system operable to regulate hydrogen flow from one or more of the electrolyis tank and the hydrogen storage tank to the ammonia reaction chamber.

11. The system of claim 9, further comprising a control system operably coupled to the compressed air source and the ammonia reaction chamber, the control system operable to regulate compressed air flow from the compressed air source to the ammonia reaction chamber.

12. The system of claim 9, wherein the compressed air source contains compressed air comprising nitrogen.

13. The system of claim 9, wherein hydrogen from one or more of the electrolyis tank and the hydrogen storage tank can react with nitrogen from the compressed air source to form ammonia within the ammonia reaction chamber.

14. The system of claim 13, wherein the ammonia comprises anhydrous ammonia.

15. The system of claim 13, wherein reactions within the ammonia reaction chamber are catalyzed using one or more catalysts.

16. The system of claim 9, wherein reactions within the ammonia reaction chamber are capable at a pressure higher than 1 atm.

17. The system of claim 9, wherein reactions within the ammonia reaction chamber are capable at a temperature higher than 30° C.

18. The system of claim 9, wherein reactions within the ammonia reaction chamber are capable at a pressure of between 150 atm and 250 atm, at a temperature between 300° C. and 550° C., and using iron oxide as a catalyst.

19. (canceled)

20. A method for producing hydrogen, the method comprising the steps of:
providing a system for producing hydrogen, comprising:
a fuel source containing fuel;
a burn chamber operably coupled to the fuel source, the burn chamber operable to burn fuel to create energy;
an electricity generator operably coupled to the burn chamber, the electricity generator operable to generate electricity from the energy from the burn chamber; and
an electrolysis tank operably coupled to the electricity generator, wherein the electricity from the electricity generator facilitates the electrolysis of water present within the electrolysis tank to form hydrogen and oxygen;
introducing the fuel from the fuel source to the burn chamber;
burning the fuel to create energy;
utilizing the energy to generate electricity using the electricity generator; and
utilizing the electricity to electrolyze water to form hydrogen and oxygen within the electrolysis tank.

21.-22. (canceled)

23. A method for producing hydrogen, the method comprising the steps of:
providing a system for producing ammonia, comprising:
a fuel source containing fuel;
a burn chamber operably coupled to the fuel source, the burn chamber for burning the fuel from the fuel source therewithin to create energy;
an electricity generator operably coupled to the burn chamber, the electricity generator operable to generate electricity from the energy from the burn chamber;
an electrolysis tank operably coupled to the electricity generator, wherein the electricity from the electricity generator facilitates the electrolysis of water present within the electrolysis tank to form hydrogen and oxygen;
an ammonia reaction chamber operably coupled to the electrolysis tank; and
a compressed air source coupled to the ammonia reaction chamber;
introducing the fuel from the fuel source to the burn chamber;
burning the fuel to create energy;
utilizing the energy to generate electricity using the electricity generator;
utilizing the electricity to electrolyze water to form hydrogen and oxygen within the electrolysis tank;
introducing the hydrogen from the electrolysis tank to the ammonia reaction chamber;
introducing nitrogen from the compressed air source to the ammonia reaction chamber; and
reacting the hydrogen and the nitrogen within the ammonia reaction chamber to generate ammonia.

24.-26. (canceled)

27. The method of claim 23, wherein the method further comprises the step of reacting the hydrogen with the nitrogen to form an ammonia-based fertilizer.

28. The method of claim 23, wherein the method further comprises the step of utilizing the hydrogen as a fuel source.

29. The system of claim 1, further comprising:
a fuel cell operably coupled to the electricity generator, wherein the electricity from the electricity generator facilitates cracking water present within the fuel cell to form hydrogen and oxygen.

30.-54. (canceled)
